(19) United States
(12) Patent Application Publication
(10) Pub. No.: US 2004/0137289 A1
(43) Pub. Date: Jul. 15, 2004

(54) Fuel cells that operate on nuclear reactions produced using rapid temperature changes

(76) Inventor: Ping-Wha Lin, Angola, IN (US)

Correspondence Address: BUTZEL LONG, 350 SOUTH MAIN STREET, SUITE 300, ANN ARBOR, MI, 48104, US

(21) Appl. No.: 10/723,396

(22) Filed: Nov. 26, 2003

Related U.S. Application Data
(63) Continuation-in-part of application No. 10/255,216, filed on Sep. 26, 2002.

(51) Int. Cl. H01M 8/04; G21C 3/56; G21C 19/28

(52) U.S. Cl. 429/17; 376/383

(57) ABSTRACT

A method of generating a nuclear reaction from a gas stream containing water which involves heating a gas stream at a rapid rate sufficient to dissociate the water into hydrogen and oxygen and to transform hydrogen ions into protons which produce nuclear reactions, including nuclear fusion. Once the reaction state is reached, no additional heat needs to be inputted into the reaction system. Electrons that are freed from chemical species during the resulting nuclear reaction can be collected and used to produce electricity. In addition, hydrogen that is produced during the resulting nuclear reaction can be collected and used as a fuel in internal combustion engines, engine driven machine or piece of equipment.

### RELATER APPLICATIONS

The present application is a continuation-in-part of U.S. patent application Ser. No. 10/255,216, filed Sep. 26, 2002 to which priority is hereby claimed under 35 U.S.C. §120 and of which the entire disclosure is hereby expressly incorporated by reference.

### TECHNICAL FIELD

The present invention relates to nuclear reaction mechanisms based on the new theory of flux. More particularly, the present invention is directed to a process of rapidly heating a gas stream containing a source of hydrogen in a manner that leads to nuclear reactions which are used to operate fuel cells.

### BACKGROUND ART

According to Lin's Theory of Flux (see U.S. Pat. No. 5,084,258), when a chemical reaction system is subjected to a high time rate of temperature change, it changes from equilibrium to non-equilibrium conditions. It has been proved mathematically that, when a gas system is subjected to a high time rate of temperature increase, the activities of particles (molecules, atoms or nuclei, and electrons) are increased: the particles are accelerated; frequencies and amplitudes of electron and atomic vibrations in a molecule increase; average kinetic energy of the particles increases; atomic bonds are ruptured; and electrons are caused to leave their orbits.

According to the present invention, the inventor has discovered that his theory of flux can be applied to systems which involve nuclear reactions that can be used to operate fuel cells.

### DISCLOSURE OF THE INVENTION

According to various features, characteristics and embodiments of the present invention which will become apparent as the description thereof proceeds, the present invention provides a method of generating electricity which comprises:

a) providing a gas stream that contains a source of hydrogen atom containing compounds;

b) applying heat to the gas stream at a rapid rate sufficient to:

i) produce hydrogen ions and free electrons from the source of hydrogen atoms;

ii) transform the produced hydrogen ions into protons; and

iii) induce a sustained chain reaction, including nuclear reactions; and

c) collecting the free electrons as a source of electricity.

The present invention further provides a nuclear reactor that produces electricity, which nuclear reactor comprises: a chamber having an upstream side and a downstream side; a gas inlet at the upstream side; a gas outlet at the downstream side; means for flowing a stream of gas through the chamber from the upstream side to the downstream side; means for heating the gas stream flowing through said chamber at a sufficient rate to cause components of said stream of gas to undergo nuclear reactions and produce free electrons; and a conductive collector for collecting and removing freed electrons from the reactor.

The present invention also provides a nuclear fuel cell that comprises: a chamber having an upstream side and a downstream side; a gas inlet at the upstream side; a gas outlet at the downstream side; means for flowing a stream of gas through the chamber from the upstream side to the downstream side; means for heating the gas stream flowing through said chamber at a sufficient rate to cause components of said stream of gas to undergo nuclear reactions and protons and free electrons; and means for cooling a portion of reactor downstream of the means for heating the gas stream so as to recombine electrons and protons to form hydrogen.

### BRIEF DESCRIPTION OF DRAWINGS

The present invention will be described with reference to the attached drawings which are given as non-limiting examples only, in which:

FIG. 1 is a diagram depicting the relationship between reaction rate and temperature for different types of chemical reactions.

FIG. 2 is a schematic side view of a vertically fired combustor.

FIG. 3 is a schematic side view of a basic nuclear fusion unit according to one embodiment of the present invention.

FIG. 4 is a schematic diagram of a general arrangement of a nuclear fusion system for space heating.

FIG. 5A is a schematic diagram of a nuclear fusion boiler for a new power plant or for retrofitting existing power plants.

FIG. 5B depicts a nuclear power plant that uses several basic nuclear fusion units equipped with a fuel cell arrangement.

FIG. 6 is a diagram depicting the relationship between a magnetic field, the direction of plasma flow and the movement of electrons.

FIG. 7 is a schematic diagram of a basic nuclear fusion unit according to one embodiment of the present invention that includes an arrangement for electric and power production.

FIG. 8 is a schematic diagram of a basic nuclear fusion unit that is similar to FIG. 7 which includes a recycle path for at least a portion of the feed gas.

FIG. 9 is a schematic diagram of a basic nuclear fusion unit that is similar to FIG. 8 which includes multiple reaction zones.

FIG. 10 is a schematic side view of a basic nuclear fusion unit according to one embodiment of the present invention that includes a steam injection port for sulfuric acid production.

FIG. 11 is a schematic diagram of a gas desulfurization process according to one embodiment of the present invention.

### BEST MODE FOR CARRYING OUT THE INVENTION

As an extension of Lin's Theory of Flux, it has been determined during the course of the present invention that when a chemical reaction system is subjected to a high time rate of temperature change, all or most of the electrons of various chemical species to leave their orbits to form a plasma which is very active chemically. When this occurs, the acceleration and collisions of particles (electrons, neutrons and nuclei) in the dynamic condition can lead to nuclear reactions.

During the course of the present invention pilot plant studies were conducted at Research Triangle, N.C. USA, for SO₂ conversion to SO₃ by rapid heating. In these studies, a 10-ft high vertically fired combustor (VFC) was used. Air containing 0.5% SO₂ was forced continuously through the VFC, where it is heated by burners for conversion of SO₂ to SO₃.

During a post idle period of operation, the burners were turned off so that no external heat was added to the system. It was observed that, as air continually passed through the VFC during a post idle period of sixteen hours, the temperature of the flowing air consistently rose rapidly from ambient temperature (90° F.) at the inlet of the VFC to an average temperature as high as 582° F. (in the range of 840° F. to 455° F.) at one section of the VFC, an increase of about 500° F.

This air flow temperature increase of such large magnitude and long duration following the initial input of heat from the burners clearly indicates that nuclear reactions were present in VFC. It was also found that the water vapor in the air stream completely disappeared in the VFC, because of no sulfuric acid, which would have resulted from the reaction of water and SO₃, was detected.

It was determined that the water vapor in the air was initially converted to hydrogen and oxygen by the rapid heating, which further lead to nuclear reactions, involving transformation of hydrogen ions to protons. In the dynamic condition, electrons are driven off from their orbits, protons are produced from hydrogen ions, and other isotopes of hydrogen are formed from electrons, neutrons and protons.

The mutual bombardments and direct impacts between the elements of the air produced various nuclear reactions including nuclear fusion which continued after the burners were shut off.

The following disclosure explains the phenomenon discovered during the course of the present invention and sets forth non-limiting practical applications of the present invention.

Many scientific accounts and tests undertaken in dynamic conditions show discrepancies in results from that predicted by the current chemical reaction theory. In search of an explanation for the reasons of the discrepancy, the present inventor developed the Theory of Flux.

Lin's Theory of Flux has shown mathematically that when a fluid system is subjected to a high time rate of temperature change, the gas becomes very active chemically. The theory proves that a high time rate of temperature change creates a short dynamic condition that causes an increase of not only chemical reaction rate but also reaction product concentrations. The validity of the theory can be substantiated by many published scientific accounts and results and by the recently conducted pilot plant study discussed below.

Conventional chemical reaction processes, conducted at constant temperature and based on equilibrium theory, are inefficient and time-consuming. If industries can develop reaction processes that are based on the Lin's Theory of Flux, both time and energy can be greatly saved.

By the applying high time rate of temperature increase to a gas flow, nuclear reactions of the fluid can be promoted, and cold nuclear fusion has become a reality. The large amount of heat continuously generated by the resulting nuclear reactions in the flowing gas (gas flow) can be utilized for space heating, power generation, desalination, and other practical applications.

Current practice for nuclear reaction and fusion development which employs very high temperatures and static conditions proves not only uneconomical but also impractical. These shortcomings can be eliminated by the use of Lin's Theory of Flux to create a dynamic condition.

A new inexhaustible natural source of energy, involving air, water, and possibly hydrogen, is waiting for development to supply the huge demand of ever increasing world population.

### Current Chemical Reaction Theory

Current chemical reaction theory, according to Vincenti and Kruger (Physical Gas Dynamics, Wiley, N.Y., 1965), is based on thermodynamic equilibrium, which includes mechanical, thermal and chemical equilibriums. Classical thermodynamics can only make predictions about states of thermodynamic equilibrium. The state of a gas system is represented by its temperature, pressure, and concentration. When a process is governed by classical thermodynamics, it must be regarded as consisting of a succession of states of thermodynamic equilibrium. The change of states is assumed to proceed very slowly or smoothly. In general, the current chemical reactor designs are based on constant reactor temperature.

The following chemical equilibrium reaction is used as an example for explanation:

A+B⇄C (1)

where A and B are reactants and C is product

The reaction rate relation is as follows:

$$\frac{ⅆ [ C ]}{ⅆ t} = {K}_{1} [ A ] [ B ] - {K}_{2} [ C ] \qquad ( 2 )$$

where K₁ and K₂ are reaction rate constants, [C] is product concentration, and [A] and [B] are chemical reactant concentrations.

In an equilibrium chemical reaction, the forward reaction coexists with the backward reaction. The backward reaction has a canceling effect upon the chemical reaction and the production of [C]. It performs useless work (negative) and thus wastes both time and energy. When product concentration reaches equilibrium concentration, the forward reaction rate is equal to the backward reaction rate, and there is no possibility for product concentration [C] to penetrate beyond equilibrium concentration. Therefore, the product yield is low.

The aforementioned disadvantages can be eliminated by subjecting the fluid to a rapid time rate of energy change, so that the reactions are changed from equilibrium to non-equilibrium conditions. Under a non-equilibrium condition, only the forward reaction exists. The conversion is based on Lin's Theory of Flux, which is described below.

### Lin's Theory of Flux

The transmission of energy in wave form is hereby called flux. There are several different types of flux, such as heat flux, electromagnetic flux, etc., depending on the frequency of the wave form. In the development of the Lin Theory of Flux, the inventor uses heat flux for illustrative purposes.

When a gas system is subjected to a rapid time rate of temperature change, the system enters into a short dynamic condition. The velocities of its molecules, atoms, and electrons will also be changed continuously. As a result, frequencies and impact of molecular collisions will be changed, bonds between atoms will rupture or be established, and electrons caused to leave their orbits or be captured. Therefore, the fluid becomes very active chemically for the required reaction.

1. Mathematical Proof

At the electron, atomic and molecular levels, as net heat is added to a gas system, the net heat is immediately transformed to enthalpy, which is the sum of internal energy of its components and pressure of the gas. Mathematically, it can be expressed as follows:

Q=F(U,P)* (3)

Where:Q=Total net heat added to a gas system

F(U,P)=functional equation.

U=Total internal energy of a gas system which is the sum of the kinetic and potential energies of the components of the system [components herein meaning molecules, atoms and electrons].

P=pressure of the gas.

* Other engineers separate F(P) from F(U).

The functional equation (3) can also be expressed as:

Q=F{KEₘ,PEₘ,KEₐ,PEₐ,KEₑ,PEₑ,P} (4)

where KEₘ=Total kinetic energy of gas molecules in the gas system=Σ½ mₘvₘ²

PEₘ=Total potential energy of gas molecules in the gas system. For a system such as a reactor of constant volume, it is a constant, k.

KEₐ=Total kinetic energy of all the atoms or nuclei (for plasma fluid) in the gas system=Σ½ mₐvₐ²

PEₐ=Total potential energy of all the atoms or nuclei (for plasma fluid) in a gas system=Σmₐrₐ

KEₑ=Total kinetic energy of all the electrons in the gas system=Σ½ mₑvₑ²

PEₑ=Total potential energy of all the electrons in the gas system=Σmₑrₑ

mₘ, mₑ, mₐ are mass of individual molecule, electron, atom or individual nucleus in plasma fluid, respectively

vₘ, vₑ, vₐ are velocity vector of individual molecule, electron, atom or individual nucleus in plasma fluid, respectively

rₐ=interatomic distance or relative position vector of atoms

rₑ=distance of individual electron from the nucleus or position vector of the electron with respect to the nucleus in an atom

Differentiating the functional equation (4) with respect to time, t, results in the following expression:

$$\frac{ⅆ Q}{ⅆ t} = \frac{\partial Q}{\partial {KE}_{m}} ( Σ {m}_{m} {v}_{m} {a}_{m} ) + \frac{\partial Q}{\partial {KE}_{a}} ( Σ {m}_{a} {v}_{a} {a}_{a} ) + \frac{\partial Q}{\partial {PE}_{a}} \{ Σ {m}_{a} ( ⅆ {r}_{a} / ⅆ t ) \} + \frac{\partial Q}{\partial {KE}_{e}} ( Σ {m}_{e} {v}_{e} {a}_{e} ) + \frac{\partial Q}{\partial {PE}_{e}} \{ Σ {m}_{e} ( ⅆ {r}_{e} / ⅆ t ) \} + \frac{\partial Q}{\partial P} \frac{\partial P}{\partial t} \qquad ( 5 )$$

Equation (5) shows that the time rate of net heat added to the gas system, dQ/dt, is accompanied by the creation of aₘ, aₐ, drₐ/dt, aₑ, drₑ/dt, and dP/dt, where

aₘ=acceleration vector of an individual molecule in the direction of vₘ

aₐ=acceleration vector of an individual atom relative to another atom in a molecule or that of an individual nucleus in a plasma fluid. The direction of aₐ agrees with that of vₐ

drₐ/dt=time rate of change of relative position vector of the atoms in a molecule

aₑ=acceleration vector of an individual orbiting electron in the direction of vₑ

drₑ/dt=time rate of change of relative position vector between an individual electron and the nucleus

dP/dt=time rate of change of pressure

From Eq (5), it is evident that the higher the time rate of the net heat added to or withdrawn from the system, the higher are the magnitudes of aₐ, aₘ, aₑ, drₐ/dt, drₑ/dt, and dP/dt. The aforementioned magnitudes can be positive or negative, depending on whether heat is added or withdrawn.

2. Effects of Time Rate of Net Heat (dQ/dt) Applied to a Fluid System

The effects of the aforementioned accelerations, aₘ, aₐ and aₑ, time rate of change of relative positions of atoms and electrons, drₐ/dt and drₑ/dt, and time rate of change of pressure, dP/dt, on chemical reaction rates are explained as follows:

2A. At the Electron Level

The orbital electrons are subject to tangential acceleration aₑ when heat flux is changed rapidly.

The tangential acceleration causes the velocity or the total energy (potential and kinetic) of an orbital electron to change. As a result, if dQ/dt in the gas system or aₑ is high enough, the velocity of orbiting electron can be accelerated to escape velocity, vₑₛₚ. The formula for vₑₛₚ calculation can be found in classical mechanics.

Because of the removal of electrons, the atom or molecule is ionized, and the ionized particles are very active chemically. If most or all of the electrons leave their orbits, the gas fluid becomes a plasma which is very active chemically.

aₑ and drₑ/dt can result in changing from bonding orbit to antibonding orbit, or vice versa. They may cause capture or release of electrons from atoms or molecules and help to establish or break the bonds, depending on the chemical reaction required.

The term drₑ/dt represents time rate of change of potential energy of the electron. When there is no heat added to the gas system, the potential energy of an electron is a function of its kinetic energy—as kinetic energy is increased, its potential energy is decreased.

However, in a dynamic system where heat is rapidly increased, drₑ/dt is the time rate of change of the position vector from center of nucleus to the electron; therefore, it is also equal to the instantaneous velocity which is tangent to the orbit of the electron. This variable velocity helps to move the electron from one orbit to another and boost the energy level of the electron. Evidently, dQ/dt can contribute to an increase of total energy of the electron. When dQ/dt is high enough, it can cause ionization of the particles (atom or molecule), or change the gas fluid to plasma state.

2B. At the Atomic level

At the atomic level, the sign of acceleration, aₐ of an atom is affected by dQ/dt. aₐ increases or decreases the magnitude of the relative atomic velocity, vₐ, of an atom with respect to other atoms in a molecule, but does not affect its direction. Since aₐ can change vₐ, it can in turn magnify the vibrational, rotational effects of the atoms in a molecule. Therefore, the molecule will expand and contract at higher frequency and its atoms spin at a faster rate of rotation. When the kinetic energy of an atom is raised to above the bonding energy of atoms in a molecule, the molecule splits.

If the particle is a nucleus in a plasma fluid, it moves freely without bonding. A high time rate of temperature increase of the fluid will cause acceleration aₐ of the nucleus which continuously changes the magnitude of vₐ but not its direction. The collision of the high speed nuclei can induce nuclear fusion and other nuclear reactions.

The rate of change of potential energy of atoms can be represented by drₐ/dt. drₐ/dt has the effect of establishing or disrupting the atomic bonds. drₐ/dt indicates that the equilibrium distance between two atoms is increased by the sudden application of heat to the system, thereby the potential energies of the atoms also increased. The increase of the inter-atomic distance tends to weaken the bonds between atoms. The atoms with weakened bonds are chemically more active to establish bonds with other atoms.

2C. At the Molecular Level

At the molecular level, when net heat is added to the gas system, if dQ/dt is positive, the gas molecule is accelerated by aₘ which is in the same direction as the gas molecular velocity before being accelerated, according to the concept of vectors. The increase of gas molecular velocities will cause an increase of the number of collisions per unit time of the gas molecules, an increase of the momentums of the molecules before impact, and the impact forces during the impact. As a result, aₘ is able to enhance chemical reaction rates of gas molecules.

In a closed gas system ( [symbol] Q/ [symbol] P) and dP/dt are positive values if time rate of temperature change dT/dt is a positive value. Therefore, the last term of equation (5), ( [symbol] Q/ [symbol] P)×(dP/dt) is a positive value if the time rate of temperature change, dT/dt, is a positive value. It is known that for a given gas mass, the higher the gas pressure, the closer the intermolecular distances between molecules, resulting in a higher reactivity.

From the aforementioned explanation, it is obvious that, when a gas system is subjected to a high time rate of temperature increase, the activity of its molecules, atoms and electrons is increased: velocities of molecules, electrons, atoms or nuclei are changed; frequencies and amplitudes of electron and atomic vibrations in a molecule increase; average kinetic energy of electrons, atoms, molecules increases; electrons are caused to leave their orbits, atomic bonds are ruptured, and the gas becomes very reactive chemically. The acceleration of nuclei in the dynamic condition can lead to nuclear reactions.

So it can be concluded that when a mixed material is subjected to a heat flux rate, the total heat flux rate is distributed among molecules, atoms or nuclei, and electrons. The average energy in each particle group increases with time, and when the energy of particle (molecule, atom, nuclei or electron) reaches its activation level, reaction takes place. The reaction can be atom-splitting reaction, a molecular built-up reaction or a nuclear reaction such as cold fusion.

3. Principle of Conversion To Non-Equilibrium Reaction

A Chemical reaction can be changed from an equilibrium to non-equilibrium condition, resulting in an increase of reaction rate and product concentration. For the type of reaction wherein the chemical reaction rate increases with an increase of temperature, the rate can be increased by a high time rate of temperature increase. For the type of reaction wherein the rate increases with a decrease of temperature, the rate can be increased by a high time rate of temperature decrease.

In a dynamic condition, the chemical reaction has only one direction, i.e. toward the production of the final product. Consider the non-equilibrium equation below, which has only forward reaction. It will be proved to be valid when the end conditions are met.

A+B→C (6)

where A and B are reactant chemicals, and C is product

The concentration of product C can be represented by the functional equation:

[C]=F{[A],[B],[M],T,t} (7)

where [C]=concentration of product C in mole/I

[A]=concentration of reactant chemical A in mole/I

[B]=concentration of reactant chemical B in mole/I

[M]=concentration of background particle in mole/I

T=temperature, absolute

t=time in second

F designates functional equation.

Differentiation of equation (7) with respect to time yields equation (8) for time rate of C produced (reaction rate) as follows:

$$\frac{ⅆ [ C ]}{ⅆ t} = \frac{\partial [ C ]}{\partial [ A ]} \frac{ⅆ [ A ]}{ⅆ t} + \frac{\partial [ C ]}{\partial [ B ]} \frac{ⅆ [ B ]}{ⅆ t} + \frac{\partial [ C ]}{\partial [ M ]} \frac{ⅆ [ M ]}{ⅆ t} + \frac{\partial [ C ]}{\partial T} \frac{ⅆ T}{ⅆ t} + \frac{\partial [ C ]}{\partial t} \qquad ( 8 )$$

From rate law relationship:

Rate 1=k[A][B], Rate 2=k[A+ΔA][B]

$$\frac{\partial [ C ]}{\partial [ A ]} = Rate 2 - Rate 1 = k [ Δ A ] [ B ]$$

In a closed system, [ΔA]=0,

therefore,

$$\frac{\partial [ C ]}{\partial [ A ]} = 0$$

In the same manner, it can be proved that

$$\frac{\partial [ C ]}{\partial [ B ]} = 0 , \frac{\partial [ C ]}{\partial [ M ]} = 0 , \frac{\partial [ C ]}{\partial t} = 0$$

Therefore, eq. (8) becomes:

$$\frac{ⅆ [ C ]}{ⅆ t} = \frac{\partial [ C ]}{\partial T} \frac{ⅆ T}{ⅆ t} \qquad ( 9 )$$

Since temperature and pressure of a closed gas system are mutually dependent, and they are directly affected by heat flux, Equation (7) can also be represented by Equation (10), below.

[C]=F′{[A],[B],[M],Q,t} (10)

where Q is net heat added to the gas system

F′ designates a functional equation

Now, the time rate of C production can also represented by the following equation:

$$\frac{ⅆ [ C ]}{ⅆ t} = \frac{\partial [ C ]}{\partial [ A ]} \frac{ⅆ [ A ]}{ⅆ t} + \frac{\partial [ C ]}{\partial [ B ]} \frac{ⅆ [ B ]}{ⅆ t} + \frac{\partial [ C ]}{\partial [ M ]} \frac{ⅆ [ M ]}{ⅆ t} + \frac{\partial [ C ]}{\partial Q} \frac{ⅆ Q}{ⅆ t} + \frac{\partial [ C ]}{\partial t} \qquad ( 11 )$$

Eq. (11) shows that the reaction rate, d[C]/dt, is dependent on the time rate of change of flux, dQ/dt [see eq.(3)].

3.1 Reaction Types According to Temperature Effect

In a static (adiabatic) condition, chemical reaction rates typically are dependent on temperature. Generally, there are three types of temperature dependent chemical reactions that the Lin's Theory of Flux will affect, namely

Type 1 chemical reactions in which the chemical reaction rate increases with an increase of temperature

Type 2 chemical reactions in which the chemical reaction rate increases with an increase of temperature in one temperature range and increases with a decrease of temperature in another temperature range.

Type 3 chemical reactions in which the chemical reaction rate increases with decrease of temperature.

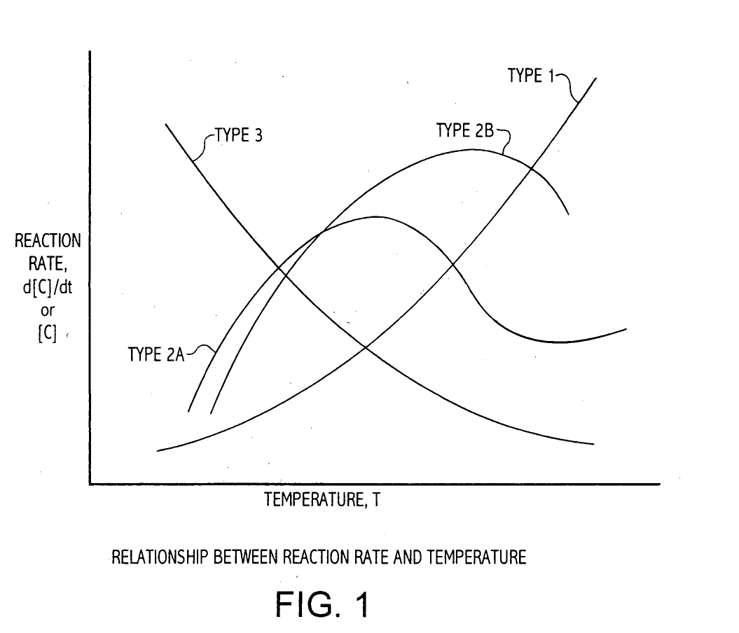

These reaction types are depicted in FIG. 1.

The following examples illustrate various reaction types:

A. Type 1 Reactions

C+O₂→CO₂

CH₄+2O₂→CO₂+2H₂O

SO₂+½O₂→SO₃ (below 950° F.)

N₂+O₂→2 NO

N₂+2O₂→2 NO₂ (at high temperatures)

CaCO₃→CaO+CO₂

2H₂O→2H₂+O₂

H₂→2e⁻+2₁¹H

Nuclear Fusion Reactions

B. Type 3 Reactions

NO+½O₂→NO₂ (at low temperatures)

SO₃→SO₂+½O₂ (below 950° F.)

SO₂→S+O₂

CO₂→C+O₂

2e⁻+2₁¹H→H₂

The production of polyethylene is an example of a type 2A reaction.

The oxidation of SO₂ to SO₃ throughout the entire temperature range is an example of a type 2B reaction.

3.2 Conversion from Equilibrium to Non-Equilibrium Conditions

With reference to equation (9), as long as d[C]/dt is a positive value, the reaction will always be moving forward in the direction of end product production. There will be no backward reaction, and the system becomes non-equilibrium. As a result, the process can be completed in a short period of time. It spends less energy, and the end product concentration can surpass the equilibrium concentration.

It is known that for type 1 reactions, [symbol] [C]/ [symbol] T is a positive value. In order to make d[C]/dt a positive value, dT/dt must be a positive value. On the other hand, for type 3 reactions, [symbol] [C]/ [symbol] T has a negative value. In order to make d[C]/dt a positive value, dT/dt must be a negative value. From this it can be concluded that for a type 1 reaction, a high time rate of temperature increase will increase the reaction rate. For the type 3 reaction, a high time rate of temperature decrease will increase the reaction rate.

On the other hand, for a type 1 reaction, if dT/dt is a negative value, d[C]/dt becomes also a negative value, resulting in a reduction of C concentration, [C]. Similarly, for a type 3 reaction, if dT/dt is a positive value, d[C]/dt becomes a negative value, resulting in a reduction of C concentration, [C].

### Lin's Theory of Flux and Nuclear Reactions

Experimental Proof by Pilot Plant Studies

In order to verify that nuclear reactions can be initiated by Lin's Theory of Flux, a pilot plant experiment was contracted out to Arcadis Geraghity & Miller (AGM). In close consultation with the inventor, AGM conducted a series of tests using a vertically fired combustor (VFC). The experiment was conducted at EPA's Experimental Research Center in Research Park, N.C. The objectives of the experiment was designed to show that the temperature of the gas fluid increases greatly after it passes through the system which does not have any heat added, and to verify that SO₂ can be oxidized to SO₃ by a high time rate of temperature increase.

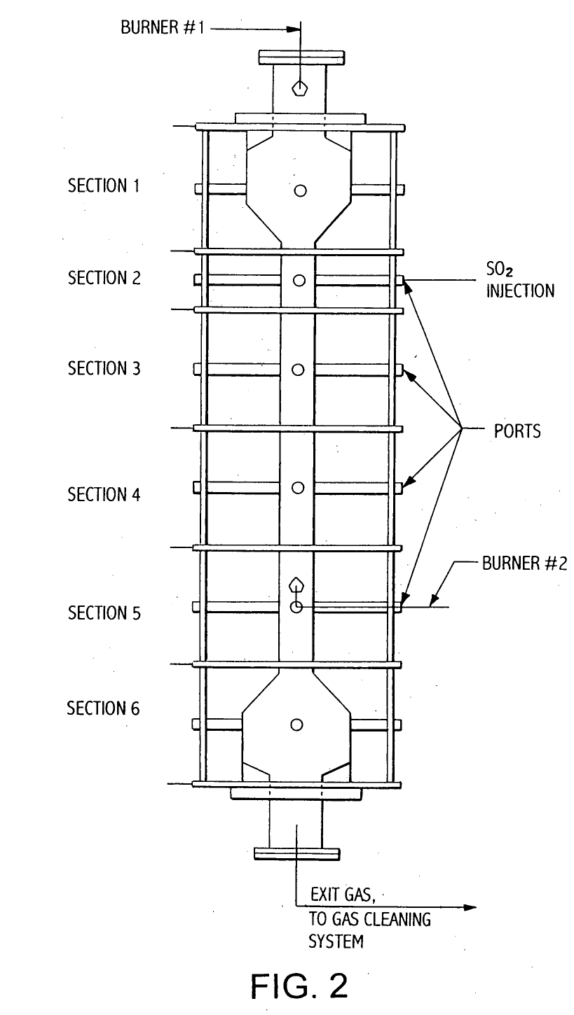

The VCF was refractory lined and had an inner diameter of 6 in. It was equipped with a number of access ports for insertion of measurement probes. FIG. 2 shows a sectional view of the VFC. Throughout the figures common reference numerals have been used to identify similar elements whenever possible to limit overly detailed descriptions of the common elements in each figure.

Two torch burners were used, namely burner #1 at the top of the combustor, and burner #2 at port No. 5. By manipulation of air to fuel ratio, the top burner #1 produced a combustion gas having a temperature of about 500° F. Sulfur dioxide gas was injected into section 2 to produce desired SO₂ concentrations. Burner #2 injected natural gas into the combustor at different times according to the designed sequence and procedures.

Flue gas components were measured using a series of continuous emission monitors (CEM) for O₂, CO₂, CO, SO₂. The different temperatures along the length of the combustor were also measured using a number of thermocouples. Both CEM and thermocouple measurements were recorded at approximately 5-second intervals throughout the test using a computerized data acquisition system.

The gases from the VFC passed through a small heat exchanger to reduce the flue gas temperature, then to a pilot scale spray dryer for control of acid gases, followed by a fabric filter for removal of particulates.

Tables 1, 2, 3, 4 are the tabulated testing results for the aforementioned objectives.

1. Proof of Conversion of SO₂ to SO₃ by Rapid Temperature Increase

With reference to FIG. 1, pure SO₂ was injected continuously at section 2 and mixed with the gas flowing downward in the combustor. Original SO₂ concentration in the mixed gas is 5030 ppm. The natural gas flow to burner #1 was shut off at 13:21. The temperatures recorded at different sections are due to the heat remaining in the combustor wall after 13:21 and the heat released from the exothermic reaction.

Table 1 shows that SO₂ can be oxidized to SO₃ by rapid temperature increase of the SO₂. Among the limited testing results, the best SO₂ conversion to SO₃ efficiency was 85.1%, measured at the sampling point at section 6. The sulfur dioxide concentration was reduced from 5030 ppm to 750 ppm.

It is known that, in the absence of a catalyst, SO₂ appears to be unreactive with O₂ at constant temperatures. A catalyst has no effect on the equilibrium composition of a reaction mixture; it merely speeds up the attainment of equilibrium.

TABLE 1
Testing Results of Gas Temperature rise due to Dynamic
Chemical Reactions

| | | | | | | Temp. | |
|---|---|---|---|---|---|---|---|
| | | | | | | Increase | |
| Time | | Section | Section | Section | Section | at | % SO₂** |
| Aug. | Qₜ* | T₃ | T₄ | T₅ | T₆ | Section | conver |
| 27, 99 | acfh | (° F.) | (° F.) | (° F.) | (° F.) | 5 (° F.)⁺ | sion |
| 14:00 | 928 | 439 | 394 | 612 | 453 | 522 | 81.3 |
| 14:05 | 927 | 438 | 392 | 601 | 459 | 511 | 85.1 |
| 14:30 | 903 | 433 | 390 | 554 | 439 | 464 | 48.3 |
| 14:35 | 902 | 432 | 390 | 553 | 438 | 463 | 48.3 |
| 14:45 | 896 | 432 | 388 | 541 | 432 | 451 | 47.9 |
| 14:50 | 890 | 434 | 391 | 565 | 444 | 475 | 49.1 |
| 14:55 | 888 | 429 | 386 | 526 | 425 | 436 | 49.9 |
| 17:25 | 844 | 406 | 369 | 459 | 375 | 369 | 24.1 |

*Average flow rate between sections 4 and 6
⁺Ambient air temperature at entrance of the combuster was 90° F.
**Based on 5020 ppm of original SO₂ concentration at point of injection at section 2

2. Proof of the High Gaseous Temperature Increase Due to Nuclear Reactions in the Dynamic Conditions

During an idle period of operation after 16:40, Aug. 26, 1998 (following operation of the VFC to oxidize SO₂ to SO₃), burners #1 and #2 were turned off so that no external heat was added to the system. It was observed that, as the air passed through the VFC during an idle period of sixteen hours as shown in Tables 2, the temperature of the flowing air consistently rose up rapidly from ambient temperature (90° F.) at the inlet of the VFC to an average temperature as high as 582° F. (in the range of 840° F. to 455° F.) at one section of the VFC, an increase of about 500° F. The temperature increase of such high magnitude and such long duration of the flow clearly indicates that nuclear reactions are present in VFC.

On Aug. 27, 1998, after the completion of SO₂ conversion to SO₃ testing, the burners in the combustor were turned off at 13:21 while an air of 510 scfh continuously passed through the VFC. The temperatures of the flowing air at different sections of VFC were measured after 14:00 and recorded in Table 3. During more than three hours observation, the temperature of the air rose from an ambient temperature of 90° F. to an average temperature of 525° F. with a range of from 612° F. to 459° F., or a temperature increase that ranged of from 521° F. to 369° F. Such a high magnitude of temperature increase verifies that nuclear reactions played an important role.

TABLE 2
Testing Results of Gas Temperature rise due to Dynamic Chemical Reactions***

| | | | | | | Temp⁺. |
|---|---|---|---|---|---|---|
| | | | | | | Increase at |
| | | Section T₃ | Section T₄ | Section T₅ | Section T₆ | Section 5 |
| | Qₜ* acfh | (° F.) | (° F.) | (° F.) | (° F.) | (° F.)⁺ |
| Time | | | | | | |
| Aug. 26, 98 | | | | | | |
| 16:40 | 2295 | 709 | 606 | 840 | 775 | 750 |
| 17:00 | 2134 | 699 | 596 | 780 | 730 | 690 |
| 18:00 | 2027 | 677 | 573 | 697 | 662 | 607 |
| 19:00 | 1969 | 659 | 558 | 657 | 619 | 567 |
| 20:00 | 1922 | 643 | 544 | 631 | 587 | 541 |
| 21:00 | 1884 | 628 | 532 | 609 | 559 | 519 |
| 22:00 | 1853 | 614 | 520 | 590 | 536 | 500 |
| 23:00 | 1827 | 601 | 509 | 573 | 515 | 483 |
| 24:00 | 1794 | 587 | 498 | 557 | 496 | 467 |
| | 1783 | 582 | 494 | 550 | 488 | 460 |
| AUG. 27, 98 0:30 | | | | | | |
| 1:00 | 1768 | 575 | 488 | 542 | 479 | 452 |
| 2:00 | 1743 | 563 | 478 | 529 | 464 | 439 |
| 3:00 | 1722 | 551 | 469 | 516 | 449 | 426 |
| 4:00 | 1702 | 538 | 460 | 505 | 436 | 415 |
| 5:00 | 1680 | 526 | 450 | 493 | 423 | 403 |
| 6:00 | 1660 | 513 | 440 | 481 | 411 | 391 |
| 7:00 | 1642 | 501 | 432 | 470 | 399 | 380 |
| 8:00 | 1623 | 490 | 423 | 460 | 389 | 370 |
| 8:30 | 1612 | 483 | 418 | 455 | 383 | 365 |
| DIFFERENCE** | 683 | 226 | 188 | 385 | 392 | 385 |
| AVERAGE | 1830 | 594 | 506 | 582 | 525 | 492 |

*Average flow rate between sections 4 and 6
**Difference between the extreme values in the range
⁺Ambient air temperature at entrance of the combuster was 90° F.
***Burner #2 was turned off at 16:09, and #1 burner was turned off at 16:30 Aug. 26, 1998. The total airflow was 955 scfh

TABLE 3
Testing Results of Gas Temperature rise due to Dynamic
Chemical Reactions***

| | | | | | | Temp. | |
|---|---|---|---|---|---|---|---|
| | | | | | | Increase | % |
| Time | | Section | Section | Section | Section | at | SO₂** |
| Aug. | Qₜ* | T₃ | T₄ | T₅ | T₆ | Section | conver- |
| 27, 98 | acfh | (° F.) | (° F.) | (° F.) | (° F.) | 5 (° F.)⁺ | sion |
| 14:00 | 928 | 439 | 394 | 612 | 453 | 522 | 81.3 |
| 14:05 | 927 | 438 | 392 | 601 | 459 | 511 | 85.1 |
| 14:30 | 903 | 433 | 390 | 554 | 439 | 464 | 48.3 |
| 14:35 | 902 | 432 | 390 | 553 | 438 | 463 | 48.3 |
| 14:45 | 896 | 432 | 388 | 541 | 432 | 451 | 47.9 |
| 14:50 | 890 | 430 | 387 | 531 | 427 | 441 | 49.1 |
| 14:55 | 888 | 429 | 386 | 526 | 425 | 436 | 49.9 |
| 15:00 | | 428 | 385 | 522 | 422 | 432 | |
| 15:30 | | 424 | 381 | 500 | 408 | 410 | |
| 16:00 | | 420 | 378 | 486 | 399 | 396 | 31.3 |
| 16:30 | | 416 | 374 | 474 | 389 | 384 | |
| 17:00 | | 411 | 371 | 465 | 381 | 375 | |
| 17:25 | 844 | 406 | 369 | 459 | 375 | 369 | 24.1 |
| Average | | 426 | 383 | 525 | 419 | 435 | |

*Average flow rate between sections 4 and 6
⁺Ambient air temperature at entrance of the combuster was 90° F.
**Based on 5020 ppm of original SO₂ concentration at point of injection at section 2
***Burner #2 natural gas flow was shut off at 13:21. No natural gas flow for the burner #1. The total airflow rate is 510 scfh

2A. The Rapid Temperature Rise in VCF is not Due to the Heat Released from Oxidation of Sulfur Dioxide

The high gas temperature increase is clearly not due to SO₂ conversion to SO₃ alone, for the temperature increase is far above the heat released from the conversion of the small concentration of SO₂ to SO₃. It can therefore be conclude that the high gas temperature increase is due mainly to other reactions.

2B. The Rapid Temperature Rise in VCF is Mainly Due to Nuclear Reactions

The heat released from chemical reactions, involving change of bonds, change positions of electrons, is not significant. According to Einstein, energy and mass are related by the equation

E=mc²

For a typical burning of carbon in oxygen, the energy lost is −393.5 kJ/mole, equivalent to −4.37×10⁻¹² kg/mole which can not be measured by a good analytical balance.

On the other hand, the heat released from nuclear reactions is very significant. The mass changes in nuclear reactions are about a million times larger per mole than those in chemical reactions. The continuously rapid increase of the temperature of the gas flow is apparently due to nuclear reactions.

2C. Hydrogen Production from Water by Rapid Heating

Hydrogen concentration in ambient air is very low, only 0.5 ppm. Such low concentration does not have any practical value in nuclear reaction development. It can be proven that hydrogen can be produced from water vapor by rapid heating by the following experiment:

Referring to the VFC in FIG. 2, the testing procedures are briefly described as follows:

(1) Burner #1 was turned on. This set up the baseline conditions for burner #2. The gas sample for the continuous monitors (CEMs, for O₂, CO₂, CO and SO₂) was taken at 11:10, Aug. 26, 1998 from the outlet of heat exchanger which is connected by a 4-in pipe approximately 40 feet from section 6 of the combustor.

(2) A stable flame was initiated with burner #2 at section 5 (without secondary combustion air due to the fact that the addition of secondary combustion air extinguished the burner #2 flame; the oxygen of the #2 burner is derived from the gas flowing from the #1 burner). Burner #2 served as a flame impinger. The combustor was allowed to equilibrate for more than three hours before the data were taken at 15:35, Aug. 26, 1998. The CEMs sampling was taken at section 7 at the heat exchanger outlet.

(3) The CEMs sampling probe was switched at 15:52, Aug. 26, 1998 from the heat exchanger outlet to the outlet of section 6 at the bottom of the combustor and the compositions of the gas therein were automatically recorded.

Testing Results

The data obtained from the above experiment is presented in Table 4 below. This data clearly shows that the Lin's Theory of Flux and the principle of conversion to non-equilibrium reaction are valid. From Table 4, it can be concluded that flue gas in ductwork is in a dynamic condition. The chemical compositions of the gas are not uniform; they change from section to section due to rapid temperature change. For a single type of reaction, changing the sign of time rate of temperature change can change a forward reaction to backward reaction.

The data in Table 4 shows that as the temperature of flue gas is rapidly increased between sections 4 and 6, SO₂ concentration is decreased by 1570 ppm, or same SO₃ concentration increased.

On the other hand, when the temperature of flue gas is rapidly decreased between sections 6 and 7, SO₂ concentration increased from 3,450 ppm at section 6 to 5,120 ppm at section 7, an increase of 1570 ppm.

From the data in Table 4 it can be seen that 1,570 ppm SO₂ is converted to SO₃ from sections 4 to 6. If water is present in the gas, SO₃ will immediately react with water to form sulfuric acid which can not be reverted to SO₂ by cooling. The fact that SO₂ concentration increased from 3,450 ppm at section 6 to 5,120 ppm at section 7 is an indication that the increase is due to the presence of 1570 ppm of SO₃ at section 6 only

On the other hand, if moisture is present in the air in the combustor environment, the 1570 ppm SO₃ at Section 6 will be converted to sulfuric acid:

SO₃+H₂O→H₂SO₄

Once sulfuric acid is formed, the SO₃ that is removed from the air can never be reverted to SO₂. The aforementioned fact that SO₂ concentration increased from section 6 to section 7 is an indication that moisture is not present in the air in the combustor. Since ambient air always contains moisture, evidently, as the air enters the combustor, the rapid heating causes the water therein to disassociate to H₂ and O₂ as follows:

2H₂O→2H₂+O₂

The disintegrated element H₂ from H₂0 is the source of proton for nuclear reaction as explained below.

TABLE 4
Testing Results Showing Changes of Gas Composition
Due to High Rate of Temperature Changes in Ductwork

| | SECTION | | | | | | |
|---|---|---|---|---|---|---|---|
| | SECTION 4 | | SECTION 5 | SECTION 6 | | SECTION 7 | |
| | (1) | | (2) | (3) | | (2) | |
| Time | Aug. 26, | | Aug. 26, | Aug. 26, | | Aug. 26, | |
| Sample | 1998 | | 1998 | 1998 | | 1998 | |
| Taken | 11:10 | | 15:35 | 15:52 | | 15:35 | |
| Temp. | 724° | F. | 1,402° F. | 1,317° | F. | 350° | F. |
| O₂ | 176,600 | ppm | — | 62,000 | ppm | 61,700 | ppm |
| CO₂ | 17,400 | ppm | — | 101,700 | ppm | 84,600 | ppm |
| CO | 646 | ppm | — | 956 | ppm | 416 | ppm |
| SO₂ | 5,020 | ppm | — | 3,450 | ppm | 5,120 | ppm |

2D. Nuclear Reactions in the Reactor

2D1. Production of Hydrogen from Water Vapor by Rapid Heating for Breaking Bonds

Production of hydrogen from water vapor by rapid heating dissociates water into H₂ and O₂ as follows:

H₂O→H₂+½O₂

2D2. Production of Deuterons from Hydrogen by Rapid Heating

The production of deuterons from hydrogen by rapid heating occurs according to the following steps:

a) Electrons are removed from their orbits around atoms in the gas to form a plasma fluid including removal of electrons from their orbits around hydrogen atoms to form protons as follows:

H₂→2₁¹H+2e

b) The collision between the accelerated positively charged protons and negatively charged electrons forms neutrons as follows:

2₁¹H+2e→2₀¹n

c) The collision between the accelerated protons and neutrons forms deuterons as follows:

2₁¹H+2₀n→2₁²H

2D3. Nuclear Fusion, Plasma

Nuclear fusion is a nuclear reaction in which light nuclei combine to give a more stable, heavier nucleus plus possibly several neutrons, with a release of energy. The fusion reactions most likely to succeed in a reactor involve the isotopes of hydrogen as follows:

₁²H+₁²H→₁³H+₁¹H (4.0 MeV)

₁²H+₁²H→₁³He+₀¹n (3.3 MeV)

₁²H+₁³H→₂⁴He+₀¹n (17.6 MeV)

₁³H+₁³H→₂⁴He+2₀¹n (11.3 MeV)

2D4. Bombardment by Acceleration of Protons, Helium, and Neutrons on Targets in Air Such as Nitrogen

The chance for possible nuclear reaction in air is between nitrogen and other light gases such as helium is great. Nitrogen is plentiful in air and helium concentration in air is about 5.24 ppm. Helium can be produced from fusion of protons as shown above. The nuclear reaction between nitrogen and helium is represented by the following nuclear reaction:

₇¹⁴N+₂⁴He→₈¹⁷O+₁¹H

The emission of high-energy particles such as protons will cause further nuclear bombardment of light gases such as Li to induce more nuclear reactions and release more energy.

Rutherford observed that there were no nuclear reactions on oxygen and heavy gases such as carbon dioxide by the alpha-particle (He) bombardment.

2D5. Gamma Rays

Gamma rays often accompany the emission of alpha and beta particles. The absorption of gamma rays by the particles in the gas is accompanied by bond-breaking and reduction of gas temperature such as at section 4 of the combustor as shown in Tables 1, 2, and 3.

2D6. Perpetual Chain Reactions for Energy Production

The heat released from nuclear reaction can maintain the temperature of the gas flow in a dynamic condition, which causes the perpetual nuclear reactions to occur, with continuous release of heat. The system becomes a source of energy production, free from all forms of pollution.

2D7. Second Nuclear Reactions

From Tables 1, 2, 3, the temperatures in the reactor invariably decrease from sections 3 to 4, increase from sections 4 to 5, and then decrease from section 5 to 6. The high temperature increases of air flow at section 5 is due to second nuclear reactions induced by burner 2, from which the flame flows countercurrent to the air flow.

3. Nuclear Fusion Reaction for Fuel Cell Application

3A. Basic Nuclear Fusion Unit for Heat Production

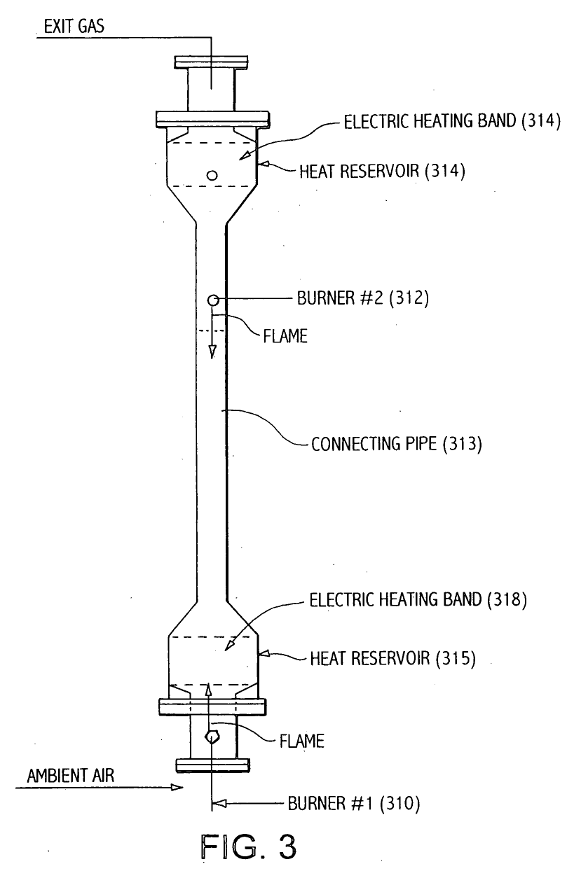

FIG. 3 is a schematic side view of a basic nuclear fusion unit according to one embodiment of the present invention.

Referring to FIG. 3, ambient air is first forced through Venturi mixer where it is optionally or selectively mixed with injected chemicals such as steam, methane, hydrogen, helium, etc. The mixed gas is then forced through the basic nuclear fusion unit 316.

Nuclear reaction can be induced in the basic nuclear fusion unit 316 by the use of burners, preferably two burners, one burner 310 (burner #1) at an upstream portion of the basic nuclear fusion unit 316 and a second burner 312 (burner #2) at a downstream portion of the basic nuclear fusion unit 316. The flame from the second burner 312 flows countercurrent with the direction of air flow. The heat released from nuclear reaction enables the temperature to remain at a high level in the basic nuclear fusion unit 316 and induces further nuclear reactions in the incoming fresh air. Therefore, the burners and heating bands are used for inducing nuclear reactions or to raise the reaction activities to higher levels. Once nuclear reactions are established, the burners can be withdrawn and/or turned off. In general, they are not used most of the time.

FIG. 3 shows that, at the inlet of the fusion unit, burner #1, 310, issues out flame in the direction of the flow at a distance upstream of the heat reservoir 315. The heated gas passes through the heat reservoir, 315, where a large portion of the heat in the flow is retained, and the nuclear fusion reactions in the flowing gas due to rapid heating produce additional heat which enhances further nuclear reactions continuously and rapidly in the flow. The heat reservoirs 314 and 315 have enlarged cross-sectional areas. The flue gas leaving from heat reservoir, 315, meets the countercurrent flame issuing out from burner #2, 312, where the second nuclear reaction is induced. More heat is generated by nuclear reaction at the section where burner #2 is located. The flue gas then passes though heat reservoir, 314, where a portion of the heat is retained. The heat reservoirs, 314 and 315, are covered by electric heating bands, 318, or provided with other supplemental heating means which supply heat to the reservoirs as needed at the time after the burners withdrawn. For long basic nuclear fusion units, more that one countercurrent burner can be used.

The two heat reservoirs, 314 and 315, are connected by connecting pipe, 313. The ratio of the cross-sectional area of heat reservoir and that of connecting pipe is preferably higher than 15.

The temperature of the gas leaving the basic fusion unit, 316, can be manipulated by several adjustments, such a concentration of the injected chemicals, intensity of the flames from the burners, flow velocity, number of counter-current burners used, and other means, to the desired level for performing its useful function that the unit, 316, is designed for.

As noted herein, an electric arc can be used to create the high rate of temperature change necessary to initiate nuclear reactions. A suitable electric arc system will include two groups of electric arcs having the same number of arcs each. The groups or arcs in one group will be aligned perpendicular to the arcs of the other group and they will be placed at different levels or different parallel planes perpendicular to the direction of gas flow though the reactor unit so that they form a thermal barrier and impart a continuous high amount of energy into the gas flow to establish a nuclear fusion zone. Once a sustained nuclear reaction is established, the arcs can be withdrawn or turned off.

3B. Basic Fusion Unit for Fuel Cell Application

3B1. Description of Fuel Cell arrangement

Plasma is a gas that is capable of conducting electricity. In the basic fusion unit according to the present invention a continuous plasma flow is established though the unit. Based upon this phenomenon, the basic fusion unit can be used as a fuel cell to produce a useful electric potential.

At a rapid dT/dt, water is dissociated to H₂ and O₂ and electrons removed from outer orbits change hydrogen into protons. A small portion of the protons collide with each other and with other particles causing fusion reactions to occur, resulting in large amount of heat generation. According to one embodiment of the present invention these reactions take place in a first heat reservoir and the subsequent fusion reaction zones.

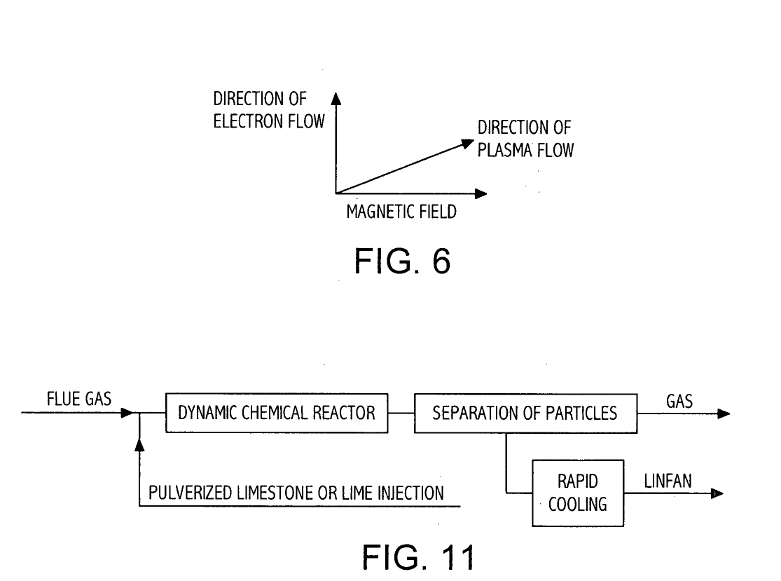

The presence of free electrons in the plasma flow may interfere with the fusion reaction mechanisms. In order to prevent such interference a magnetic field can provided to move electrons in one direction, and protons in opposite direction. According to the right hand rule, the magnetic field, direction of plasma flow (conductor) and electron movement are mutual perpendicular as show in FIG. 6 which is a diagram depicting the relationship between a magnetic field, the direction of plasma flow and the movement of electrons.

When a gas flow is subject to rapid temperature change, the application of a magnetic force on electrons in their orbits can help to not only change the magnitude of the velocity of the electrons but also direction along which the electrons move, thus further helping to remove electrons from their orbits.

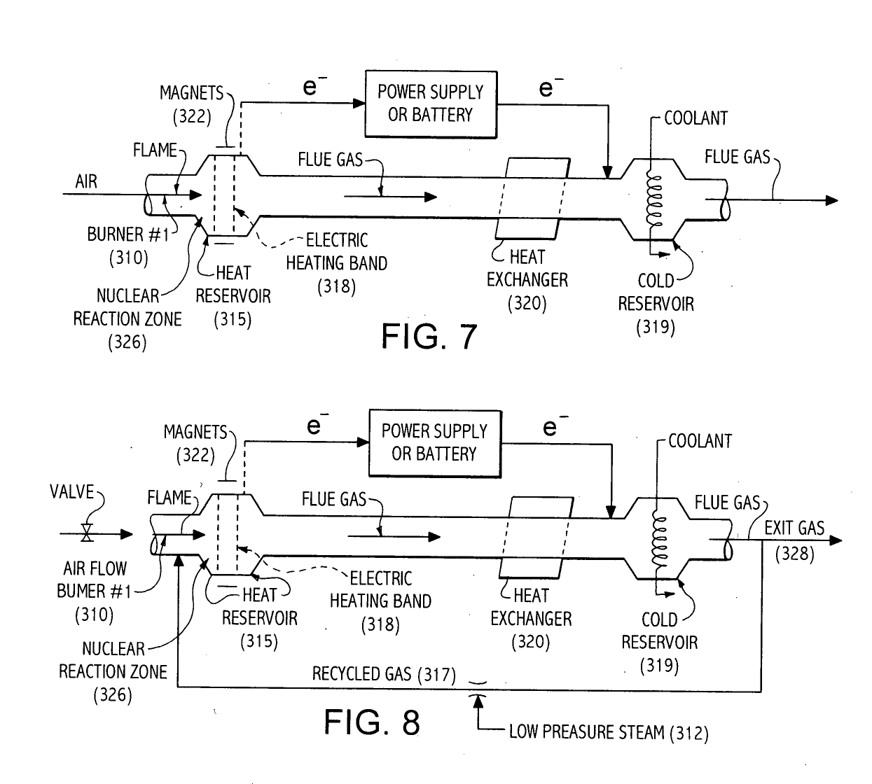

FIG. 7 is a schematic diagram of a basic nuclear fusion unit according to one embodiment of the present invention that includes an arrangement for electric and power production. FIG. 8 is a schematic diagram of a basic nuclear fusion unit that is similar to FIG. 7 which includes a recycle path for at least a portion of the feed gas.

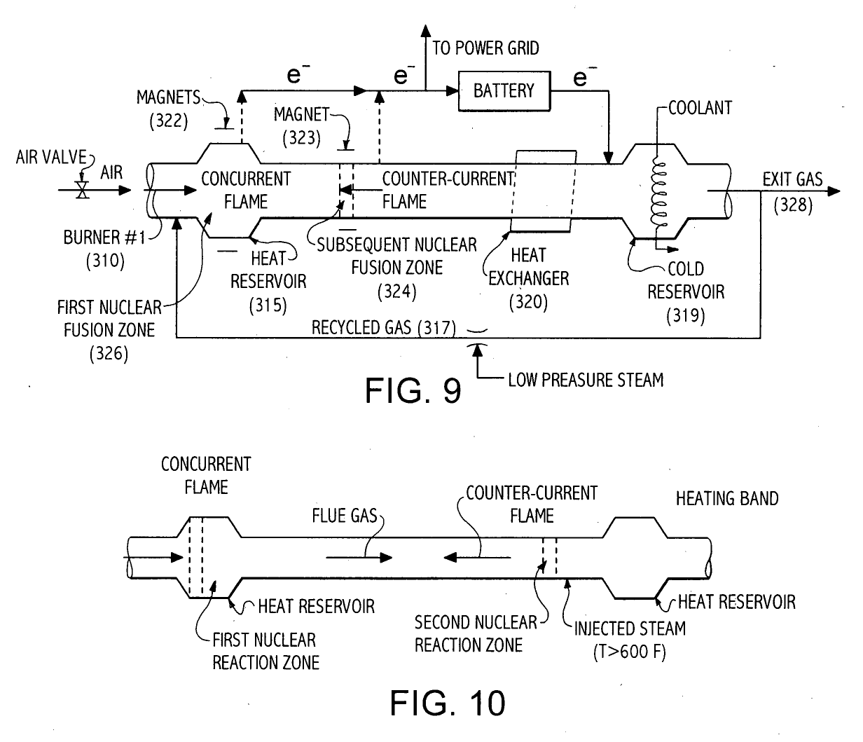

The magnetic force acting on the electrons or the potential of the current derived from the plasma flow is dependent on the velocity of the plasma flow moving across the magnetic field and the intensity of magnetic field. For optimum operational conditions the magnetic field should be provided at a heat reservoir or at a pipe immediately adjacent a heat reservoir where the plasma flow velocity is high in a system as exemplified in FIG. 7 in which magnets 322 are provided adjacent heat reservoir 315. When multi-nuclear reaction zones are used in the system, magnetic fields can also be provided by magnets 323 at nuclear fusion zones where additional fusion reactions take place as exemplified in FIG. 9 which is a schematic diagram of a basic nuclear fusion unit that is similar to FIG. 8 that includes multiple reaction zones.

Permanent magnets or electromagnets can be used to provide the desired magnetic field. The magnetic field can be strengthened by orienting the magnetic field so that it is collinear with the earth's magnetic field.

In order to facilitate the collection of free electrons released during the fusion reactions, the inner surface of the reactor where the magnetic field is provided, e.g. the inner surfaces of the heat reservoir or subsequent nuclear fusion zones are provided with conductive plates such as copper plates or plates made of any suitable conductive material. Under the influence of the magnetic field the free electrons move across the plasma flow and hit the conductive plates. The electrons are continuously collected by the conductive plates which are coupled to one or more electric terminals that convey the collected electrons out to one or more electric cables. The collected electrons can be used to perform various kinetic work such as for powering an automobile and other mechanical equipment, by providing a potential difference to cause the collected electrons to have any necessary electrical potential. The collected electrons can also be stored in a storage battery. In FIGS. 7 and 8 the freed electrons are depicted as being passed through a power supply or used to charge a battery before being recycled back into the reactor downstream of nuclear reaction zone 316 and upstream of cold reservoir 319. Conductive distribution plates or screens made from copper or any suitable conductive material can be used to introduce the electrons back into the reactor.

After completion of any kinetic work, the collected electrons are reintroduced into the reactor at a point before a cold reservoir where they are mixed with and react with protons in the plasma flow before entering the cold reservoir.

As the free electrons are being collected, positive ions such as protons move in an opposite direction in the magnetic field with a small number of them sticking to the surface of the reactor wall, if the wall is made of non-conductive material. The stuck positive ions tend to repulse further deposition of positive ions. Most of the positive ions including protons in plasma flow downstream beyond the influence of the magnetic field.

The heat from nuclear fusion in the plasma flow is continuously transmitted out from the system by heat exchangers at the downstream side of the basic fusion unit near cold reservoir. For rapid heat transfer, the pipe of the reactor in the heat exchanger section 320 can optionally be configured as a coil.

The protons in the plasma flowing from the heat exchanger react with the electrons entering at the section immediately before the cold reservoir where the gas temperature has already been lowered by heat exchangers. As free electrons and protons enter the cold reservoir where flow velocity and temperature are further reduced because of the enlargement of pipe section, the free electrons re-enter into orbits or otherwise increase the mass of nucleus of the protons in a type 3 dynamic reaction

The re-entry of electrons into the orbits of protons results in a mass increase of the nucleus. Clearly this is a type 3 reaction. That is, in a static condition the reaction rate increases with decrease of temperature. It has been proved that for a type 3 reaction in a dynamic condition, the reaction rate increases with the time rate of temperature decrease. The rapid decrease of temperature is due to the enlargement of flow section at the cold reservoir and the mass increase of nucleus of the following type 3 reaction:

2e+2₁¹H→H₂

According to one embodiment of the present invention a coolant can be used continuously or intermittently to lower the temperature of the gas in the cold reservoir to initiate or to accelerate the reaction. A cold barrier can also be formed at the cold reservoir to further help to promote the aforementioned type 3 reaction perpetually.

Other type 3 dynamic reactions that are promoted at or inside the cold reservoir include:

2H₂+O₂→2H₂O

2NO→N₂+O₂

CO₂→C+O₂

The aforementioned reactions have the potential to restore a flue gas fed into the reactor to an original fresh air condition. The exiting gas, rich in water, hydrogen, protons and other fusion reactants can be advantageously recycled back to the basic fusion reactor for continuous nuclear fusion reactions in the reactor. Steam or air can be used to replenish or replace the flow in the reactor as required as depicted in the recycled gas line 317 in FIG. 8.

Ambient air and burners can be used to start the nuclear fusion reactor and process of the present invention, because of the oxygen in ambient air and fuel from burner for combustion. Once fusion is established, a portion of the exiting gas can be recycled for heat generation together with low pressure steam to replenish any gas bleed off at the end of the system. The inlet line carrying ambient air can be completely or intermittently shut off. After an initial period of operation, the reactor becomes a self-sustain energy production system. The nitrogen concentration in the recycled gas gradually reduces to a minimum. As a result, after a period of operation, the concentration of the pollutant NOₓ in the bleed gas or exiting gas becomes insignificant.

FIG. 7 shows the use of the basic fusion reactor with single reaction zone for fuel cell application. This arrangement can be used as a stationary source for generating electricity generation and for supplying heat and power for a single house, an apartment, or a small community. A similar portable or mobile unit can be used to power an automobile, a train, etc.

3B2. Advantages of the Fuel Cell System:

Fusion reactions are always accompanied by the release of gamma rays. The absorption of gamma rays by chemical species in a gas phase results in a sudden reduction of temperature which promotes type 3 reactions between electrons and protons, causing a subsequent reduction of gas temperature in the dynamic reactor. Therefore, by channeling out most of the electrons from nuclear fusion zones, less heat from the fusion reactions will be reduced by eliminating or at least limiting the occurrence of type 3 reactions. As a result, more heat will remain available from the reactor for practical applications.

The electrons collected can be used for many practical applications before being re-introduced back into the reactor. After performing practical work, the electrons are re-introduced in the reactor to combine with protons for hydrogen production.

The exiting flow rich in hydrogen can be recycled into the reactor for further plasma fluid production. The recycled flow can be replenished or supplemented with low pressure steam. After a period of operation, the nitrogen in the air is replaced by steam which does not contribute NOₓ pollution as air does. As a result, the recycled fuel cell system offers the advantages of higher energy production efficiency, simple pollution-free operation, and a self-sustained nuclear fusion system.

3C. Practical Application of the Nuclear Reaction Induced by Rapid Heating or High Time Rate of Temperature Increase with Fuel Cell Arrangement

3C1. Space Heating

The nuclear reactions generate a large amount of heat. The rise of the temperature of the air passing through a nuclear fusion unit according to the present invention from ambient temperature to as high as 600° F. or more has been demonstrated. Such high levels temperature of the gases can be used in central heating units for heating apartments, small communities, etc.

When the temperature of air from the basic nuclear fusion unit, 316, becomes too high, coolant injection can be used to bring the temperature down to a comfortable level before entering radiators or other heat exchangers or distributors.

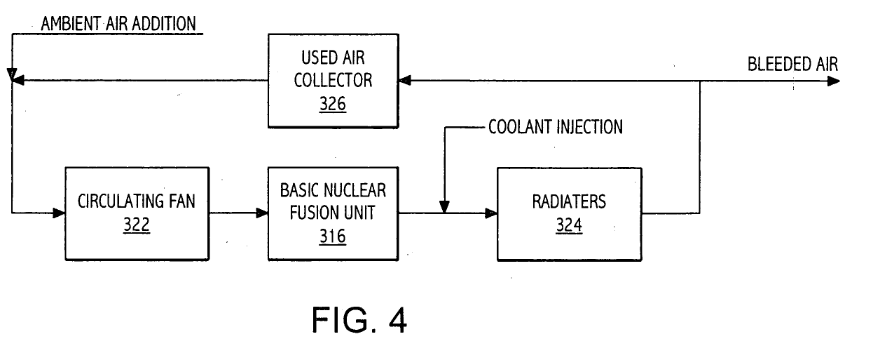

FIG. 4 is a schematic diagram of a general arrangement of nuclear fusion system for space heating. The arrangement or system includes one or more of the basic nuclear fusion units 316 depicted in FIG. 3. A circulating air fan 322 controls the flow of gases (recirculated and supplemental ambient air) into the basic nuclear fusion unit(s) 316. The heated gases exiting the basic nuclear fusion unit(s) 316 pass through one or more radiators 324 or other heat exchangers which distribute heat into a space such as a house or other building or dwelling to be heated. If necessary, the temperature of the heated gases exiting the basic nuclear fusion unit(s) 316 can be adjusted, i.e., lowered, by injecting a coolant gas therein as indicated. Alternatively, an auxiliary heat exchanger could be provided upstream of radiator(s) 324 to lower the temperature of the heated gases reaching the radiator(s) 324.

Heated gases exiting the basic nuclear fusion unit(s) can be recirculated and can be supplemented with ambient air or a portion can be bleed off as necessary and depicted in FIG. 3. It is also possible to inject moisture and other temperature-controlling gases into the gas fed into the basic nuclear fusion unit(s) as discussed herein.

The basic nuclear fusion unit with a fuel cell arrangement shown in FIGS. 7 and 8 can be advantageously used in place of the basic fusion unit 316 shown in FIG. 4 for electric generation.

3C2. Power Generation

1. Power Generation Improvement

Currently, the temperature at the top of commercial furnace is about 2,000° F. In order to make the energy generating process using rapid heating useful, valid, applicable to the currently used equipment, the target temperature is 2000° F. As mentioned previously, on the per mole basis, nuclear reactions can generate one million times more energy than ordinary chemical reactions. In order to achieve higher energy production of the system, the concentrations of the materials producing nuclear fusion reactions must be increased. It can be achieved by the following four methods:

a. Inject low-heat steam into the air before it enters the basic nuclear fusion unit for increase of hydrogen production rate in the unit.

b. Inject methane into the air before it enters the basic nuclear fusion unit in order to increase the hydrogen concentration from splitting methane in the basic fusion unit.

c. Inject hydrogen into the air before it enters the basic nuclear fusion unit in order to increase the temperature of the air to 2000° F. or higher at the exit of the unit.

d. Inject helium into the air before it enters the basic nuclear fusion unit in order to increase the temperature of the air to 2000° F. or higher at the exit of the unit.

e. Increase time rate of temperature change of the gas flow in the basic fusion unit by Increasing heat input to the gas flow from the burner and that of gas flow rate.

f. Use more counter-current flame burners arranged in series along the basic fusion unit to induce more nuclear reactions, resulting in higher temperature at reactor outlet.

2. Nuclear Fusion Power Plants

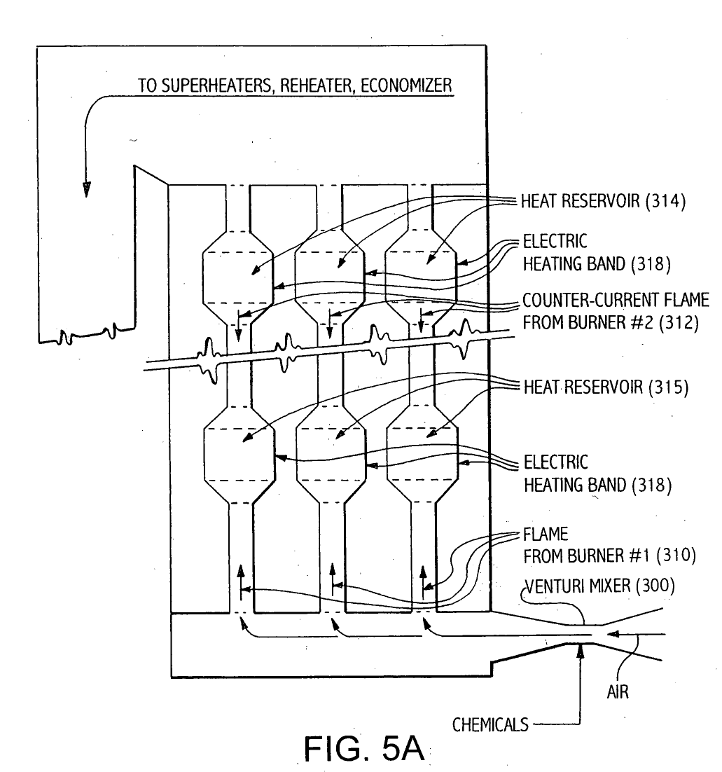

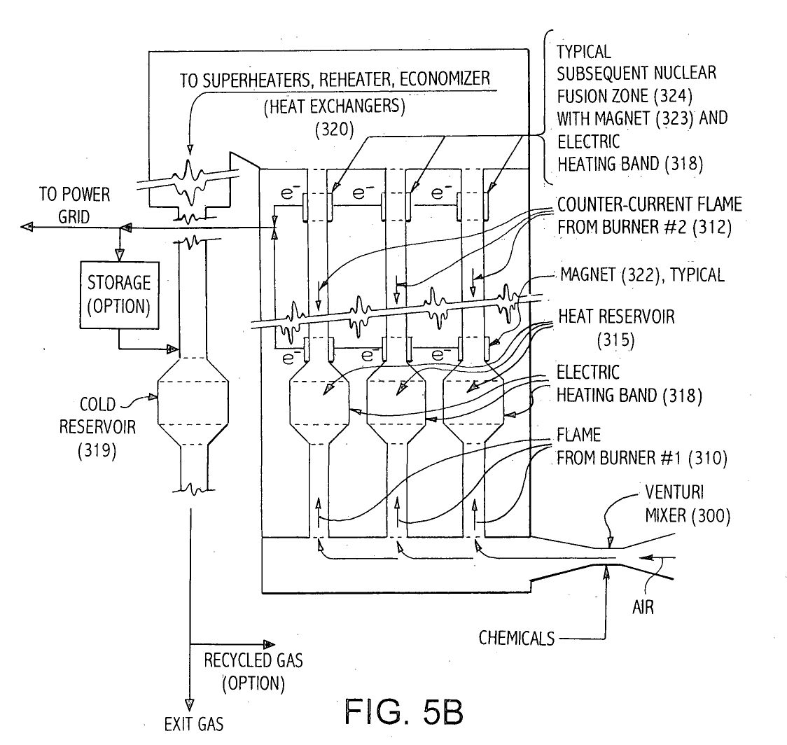

FIG. 5A is a schematic diagram of nuclear fusion boiler for a new power plant or for retrofitting existing power plants. The nuclear fusion boiler includes a bank or array of the basic nuclear fusion units exemplified in FIG. 3 above. In FIG. 5A elements that are common with the basic nuclear fusion unit of FIG. 3 are identified by common reference numerals for convenience and reference is accordingly made to FIG. 3 for a description of these common elements. Chemicals such as steam, methane, helium, are added to the ambient air at the venturi mixer 300. The mixed flow is continuously distributed to the basic nuclear fusion units 316 where fusion reactions cause large amounts of heat to be generated, resulting in a rapid increase of air temperature as it passes through the units. The high temperature air is collected and sent continuously to conventional superheaters, reheaters, and economizers (not shown) for power generation.

The basic nuclear fusion units in the boiler should be properly spaced so that workers can enter the boiler for performing maintenance work. They should also be strengthened structurally using suitable bracing.

FIG. 9 shows a basic nuclear fusion unit with multiple fusion reaction zones, a fuel cell arrangement and a recirculation system. The unit exemplified in FIG. 9 is suitable for use in nuclear power plants. Electrons collected from the unit can be issued out as electric current to a power grid system or used for storage as indicated. FIG. 5B depicts a nuclear power plant that uses several basic nuclear fusion units equipped with a fuel cell arrangement. In FIGS. 9 and 5B heat exchanger 320 can be a superheaters, heaters, economizers, etc. and the cold reservoir 319 is at a downstream side of the heat exchanger 320.

The boiler, employing the basic nuclear fusion units can be placed vertically or horizontally, new or retrofitting, to suit local conditions and requirements.

3C3. Hydrogen Production by Dynamic Reactions

1. Production of Hydrogen from a Fluid Containing Water by Using Proper Rapid Heating Rate.

Hydrogen can be produced by first rapidly heating water to break the water into hydrogen and oxygen as indicated above in the list of type 1 reactions. The hydrogen can then be separated and collected using conventional techniques.

2 . Production of Hydrogen ion from a Fluid Containing Water by Rapid Heating and then by Rapid Cooling in Fuel Cell Arrangement

Hydrogen can be produced according to one embodiment of the present invention by first using nuclear reactions produced by rapid temperature changes to break water in a flow to protons, electrons, and oxygen Ions but by controlling the rapid heating to prevent or limit fusion reactions.

Next the freed electrons are recombined with the protons to form hydrogen in the plasma flow by rapid cooling in fuel cell arrangement and the thus produced hydrogen is separated and collected using conventional techniques.

The aforementioned proper heating rate or rapid cooling rate can be controlled by controlling the velocity of gas flow, or configuring the reactor extend/reduce the reaction zone, add external heat or cooling, etc.

The gas stream that exits from the reaction unit is rich in hydrogen and oxygen and can be used directly as fuel for a combustion engine to power an automobile or any engine driven machine or piece of equipment. The reactor unit can even be mounted in and become an integral part of an automobile.

3C4. Promote Chemical Reactions

The basic fuel cell arrangement of the present invention can be used in conjunction with any number of applications that involve chemical reactions as exemplified by the following:

3C4-1. Sulfuric Acid Production:

SO₂ can be converted to SO₃ by the use of rapid heating according to the following reaction mechanism: SO₂+O₂→SO₃

Rapid heating can also split water to oxygen and hydrogen, and hydrogen atoms can further be changed to protons and other isotopes for nuclear energy productions using rapid heating as discussed above. Therefore, the gas in the reactor becomes extremely dry, and there is no water to react with SO₃ to form sulfuric acid.

Steam at about same temperature or higher than the temperature of the gas in the reactor is injected into the gas. The injected steam is subject to a temperature decrease rate according to principle of Lin's Theory of Flux and does not dissociate into hydrogen and oxygen, but is available for sulfuric acid production according to the following reaction mechanism:

SO₃+H₂O→H₂SO₄

The steam should be injected after the last fusion zone when a reactor having multi-fusion zones is used.

Once SO₃ is removed from the gas by formation of H₂SO₄, the balance between SO₂ and SO₃ is destroyed, and there is no opportunity for SO₃ to revert to SO₂. Accordingly, the reaction for the conversion of SO₂ to SO₃ is driven as a one-way reaction so that SO₂ is continuously converted into SO₃, while the SO₃ is continuously removed by reaction with water until all the SO₂ is converted rapidly to sulfuric acid mist.

The condensation temperature from sulfuric acid gas to sulfuric mist which is dependent on the sulfuric acid concentration is in generally about 600° F. In order to separate sulfuric gas from the gas in reactor, the reactor gas must be lowered to a temperature preferably below 500° F. and above 300° F., so that water will not be condensed out from the gas. When water present in the gas, it will react with SO₃ to form diluted sulfuric acid which is very corrosive and should be prevented.

The condensation of sulfuric acid in the gas can be effectively achieved by rapid cooling.

FIG. 10 is a schematic side view of a basic nuclear fusion unit according to one embodiment of the present invention that includes a steam injection port for sulfuric acid production. The reactor in FIG. 10 employs rapidly heating to affect nuclear reactions and for converting SO₂ to SO₃. A feed such as a flue gas containing air and SO₂ is fed into the inlet of the reactor. The SO₂ in the feed gas is converted into SO₃ by rapid heating in the first nuclear reaction or fusion zone. Seam is injected at a temperature equal or higher the gas in the reactor after the second nuclear reaction or fusion zone for reacting with the SO₃ to form sulfuric acid gas in heat reservoir. After formation of the sulfuric acid the gas mixture is cooled to a temperature of about 250° F. for sulfuric acid mist formation while avoiding the formation of water. Sulfuric acid mist is subsequently separated from the gas by filtration or by condensation in a conventional manner.

The steam used for sulfuric acid production should be injected after the last nuclear reaction or fusion zone in the basic fusion unit when multi-nuclear reaction or fusion zones are used. Although two nuclear reaction or fusion zones are depicted in FIG. 10 together with two flame burners, for sulfuric acid production it is possible to use only one burner before a single heat reservoir.

As discussed above, gamma rays are invariably produced in nuclear fusion reactions. The absorption of gamma rays by the chemicals in a gas mixture can cause the temperature of the gas mixture to lower. A rapid reduction of temperature of a gas mixture favors type 3 reactions. Therefore, the following reactions take place after the nuclear fusion zone:

CO₂→C+O₂

Apparently, the fusion reactor will not cause the release of air pollutants such as NOₓ, COₓ and SOₓ, and is air pollution free. However, elemental carbon should be removed from the exit gas before releasing it to atmosphere.

The fuel cell arrangement according to the present invention which involves collecting, removing, and re-introducing free electrons can be advantageously added to the basic fusion unit for sulfuric acid production.

3C4-2. Removal of Hydrogen Sulfide from Flue Gas

Removal of H₂S from a flue gas stream such as in refinery is one potential use of the nuclear reactor/fuel cells of the present invention. H₂S causes corrosion and is destructive to pipe lines, heat exchangers, and other processing and scrubbing equipment. When H₂S is rapidly heated it dissociates into H₂ and S according to the following reaction mechanism:

H₂S→H₂+S

When H₂S is rapidly heated in a nuclear reaction or fusion zone using a basic reactor unit of the present invention, the dissociated H₂ undergoes nuclear fusion reactions, resulting in a large amount of heat generated. In the mean time, the dissociated S is oxidized to SO₃ which is subsequently removed by injected steam for sulfuric acid production as discussed above

The fuel cell arrangement can be advantageously added to the basic fusion unit for hydrogen sulfide removal, electric and heat production similar to FIG. 9.

3C4-3 Production of Lime from Limestone

Conventional lime production is very energy intensive and time consuming. Depending on the kiln design and limestone size range, the net heat usage is in the range of 860-1800 Kcal per kg of lime produced, or 3.1×10⁶−6.5×10⁶ Btu per ton of lime produced. The calcining time is long and it depends on temperature of calcinations and limestone size range.

Lime can be advantageously produced from limestone by the use of the basic fusion unit of the present invention. The procedure is described as follows:

1. A mixture of air and ground limestone is fed into the basic fusion unit.

2. Moisture in the air is dissociated into oxygen and hydrogen, and the heat released from fusion reactions by isotopes of hydrogen due to high rate of temperature increase causes the splitting of limestone into lime and CO₂ according to the following reaction mechanism:

CaCO₃→CaO+CO₂

3. CaO is separated from the gas stream. This separation can be achieved by an electro-static precipitator, filter bags or other conventional means. The separation is done before carbon is condensed out from CO₂ due to rapid cooling. The lime so collected will be relatively pure material and not contaminated by carbon black.

3C4-4 Splitting of Fuel Oil

The basic fusion unit of the present invention can be used to split fuel oil as follows:

1. A mixture of air and fuel oil is fed continuously into the basic fusion unit

2. The high temperature increase rate at the inlet of the fusion unit causes fuel oil to be transformed to light hydrocarbon chemicals such as CH₄, C₂H₆, etc.

3C4-5 Sulfur Dioxide Removal from Gas Emission from Industrial Plants

SO₂ in flue gas from industrial plant such as power plant burning high sulfur fuel can be removed by lime or limestone in a dynamic chemical reactor.

FIG. 11 is a flow diagram which illustrates this process. Lime or pulverized limestone is injected to the flue gas containing SO₂ before entering the dynamic chemical reactor. Rapid heating at the entrance of the reactor causes SO₂ to be oxidized to SO₃, which reacts with lime to form CaSO₄ on the surface of the lime particles which are then subject rapid cooling to form Linfan. Linfan is a lime particle coated with a surface cracked CaSO₄ coating. Linfan has many diversified industrial applications, such as reagent for water and wastewater treatment, construction materials, etc.

The basic reaction units of the present invention, including those having one or more nuclear reaction or fusion zones and those that include or further include fuel cell arrangements for collecting and utilizing free electrons have many applications including: rapid heating to induce dynamic chemical reactions in which water or moisture in the air flow is split to hydrogen and oxygen; rapid heating that induces nuclear reactions wherein protons, deuteron and helium are formed and react with the major elements such as nitrogen, resulting in the continuous generation of large amounts of heat which can be used for space heating and other purpose; injection of hydrogen, helium, or both to promote an increase in nuclear reactions, resulting a higher rate of heat generation that can be employed for power generation; hydrogen production; production of electricity; energy production; power production; sulfuric acid production; removal of hydrogen sulfide removal from flue gas; lime production directly from limestone; flue gas desulfurization and Linfan production; and cracking fuel oil among other uses and applications which will be apparent to those skilled in the art.

Although the present invention has been described with reference to particular means, materials and embodiments, from the foregoing description, one skilled in the art can easily ascertain the essential characteristics of the present invention and various changes and modifications can be made to adapt the various uses and characteristics without departing from the spirit and scope of the present invention as described above.

What is claimed is:

1. A method of generating electricity which comprises:
a) providing a gas stream that contains a source of hydrogen atom containing compounds;
b) applying heat to the gas stream at a rapid rate sufficient to:
i) produce hydrogen ions and free electrons from the source of hydrogen atoms;
ii) transform the produced hydrogen ions into protons; and
iii) induce a sustained chain reaction, including nuclear reactions; and
c) collecting the free electrons as a source of electricity.

2. A method of generating electricity according to claim 1, further comprising:
terminating the application of heat to the gas stream after the sustained chain reaction, including nuclear reactions are induced; and
allowing the sustained chain reaction, including nuclear reactions to continue in reactive species of the gas stream.

3. A method of generating electricity according to claim 1, wherein the nuclear reactions include nuclear fusion.

4. A method of generating electricity according to claim 1, wherein the gas stream comprises one of air and a flue gas.

5. A method of generating electricity according to claim 1, wherein the rapid heating performed in step a) is performed by using at least one of a flame generator, a laser beam, an electric arc and a microwave generator.

6. A method of generating electricity according to claim 1, further comprising the step of adding chemical reactant species into the gas stream and collecting a chemical reaction product produced from the added chemical reactant species.

7. A method of generating electricity according to claim 1, further comprising recovering heat produced from the sustained chain reaction.

8. A method of generating electricity according to claim 1, wherein the step of applying heat to the gas stream at a rapid rate produces protons from the source of hydrogen atoms, and the method further comprises reacting the collected free electrons with the protons away from an area where the chain reaction occurs.

9. A method of generating electricity according to claim 8 further comprises cooling the gas stream to facilitate reacting the collected free electrons with the protons.

10. A nuclear reactor that produces electricity, which nuclear reactor comprises: a chamber having an upstream side and a downstream side; a gas inlet at the upstream side; a gas outlet at the downstream side; means for flowing a stream of gas through the chamber from the upstream side to the downstream side; means for heating the gas stream flowing through said chamber at a sufficient rate to cause components of said stream of gas to undergo nuclear reactions and produce free electrons; and a conductive collector for collecting and removing freed electrons from the reactor.

11. A nuclear reactor that produces electricity according to claim 10, wherein the means for heating the gas stream flowing through said chamber comprises a first means and a second means for heating the gas stream with the first means for heating the gas stream being upstream of the second means for heating the gas stream.

12. A nuclear reactor that produces electricity according to claim 10, further including means to re-introduce the removed electrons into the reactor downstream of the means for heating the gas stream.

13. A nuclear reactor that produces electricity according to claim 12, further including means for cooling the gas stream which means for cooling is downstream of the means to re-introduce the removed electrons into the reactor.

14. A nuclear reactor that produces electricity according to claim 10, further including a heat exchanger for recovering heat from the reactor, the heat exchanger being located downstream of the means to heat the gas stream

15. A nuclear reactor that produces electricity according to claim 10, wherein the means to heat the gas stream flowing through the chamber comprises at least one of a flame generator, a laser beam, an electric arc and a microwave generator.

16. A nuclear reactor that produces electricity according to claim 11, wherein both the first and second means to heat the gas flowing through the chamber comprises flame generators which direct flames toward each other.

17. A nuclear reactor that produces electricity according to claim 10, the chamber includes a heat reservoir near at least one of the upstream side and the downstream side.

18. A nuclear reactor that produces electricity according to claim 10, further comprising means to inject a chemical species for increasing nuclear reaction activities into the stream of gas flowing through the chamber.

19. A nuclear fuel cell that comprises: a chamber having an upstream side and a downstream side; a gas inlet at the upstream side; a gas outlet at the downstream side; means for flowing a stream of gas through the chamber from the upstream side to the downstream side; means for heating the gas stream flowing through said chamber at a sufficient rate to cause components of said stream of gas to undergo nuclear reactions and protons and free electrons; and means for cooling a portion of reactor downstream of the means for heating the gas stream so as to recombine electrons and protons to form hydrogen.

20. The combination of a nuclear fuel cell according to claim 19, in an internal combustible engine vehicle wherein the hydrogen is used as a fuel in internal combustible engine.
